(19) United States
(12) Patent Application Publication
(10) Pub. No.: US 2007/0295521 A1
(43) Pub. Date: Dec. 27, 2007

(54) HAND POWER TOOL

(76) Inventors: Juergen Wiker, Hangzhou (CN); Joachim Schadow, Dettenhausen (DE); Joerg Maute, Sindelfingen (DE)

Correspondence Address: STRIKER, STRIKER & STENBY, 103 EAST NECK ROAD, HUNTINGTON, NY, 11743, US

(21) Appl. No.: 11/744,529

(22) Filed: May 4, 2007

(30) Foreign Application Priority Data
Jun. 21, 2006 (DE) 10 2006 027 785.6

(51) Int. Cl. B25D 17/24

(52) U.S. Cl. 173/162.1

(57) ABSTRACT

In a hand power tool, having at least one first housing part for receiving at least one electric motor and at least one second housing part for receiving at least one gear, the electric motor and the gear are connected to one another, and the first housing part and the second housing part are connected, and in the connection region between the first housing part and the second housing part, at least one damping element is provided.

### CROSS-REFERENCE TO A RELATED APPLICATION

The invention described and claimed hereinbelow is also described in German Patent Application DE 102006027785.6 filed on Jun. 21, 2006. This German Patent Application, whose subject matter is incorporated here by reference, provides the basis for a claim of priority of invention under 35 U.S.C. 119(a)-(d).

### BACKGROUND OF THE INVENTION

The present invention relates to a hand power tool.

In work with electric power tools, more or less pronounced vibration occurs, which is due, among other factors, to the imbalance of the masses of the motor, gear, tool inserts, and so forth that rotate at high rpm, and to the machining of workpieces. The vibration is transmitted to the electric power tool user via the handle and cause fatigue in the user's hand. In jobs that take a relatively long time and involve electric power tools that vibrate severely, the user's health can even be impaired.

In German Patent Disclosure DE 195 25 251 A, a vibrating tool is described that has vibration insulation, for insulating the handle from vibration generated by the vibrating tool. The tool housing is provided with a protrusion that must be made to engage the handle. The handle in turn comprises two handle elements, so as to hold the protrusion of the tool housing between them. The protrusion is in engagement with an interstice, located between them, in the handle, so that the tool housing and the handle can move relative to one another.

Between the handle and the body housing, an elastically compressible element is inserted, for damping vibration. The tool known from DE 195 25 251 A has the disadvantage that the tool housing and the handle must have a geometry adapted to one another, so that a protrusion of the tool housing can be made to engage the handle. Moreover, the vibration insulation must have an appropriate geometry to assure vibration damping between the engaged tool housing and the handle.

### SUMMARY OF THE INVENTION

Accordingly, it is an object of the present invention to provide a hand power tool, which is a further improvement of the existing hand power tools.

In keeping with these objects and with others which will become apparent hereinafter, one feature of the present invention resides, briefly stated, in a hand power tool, comprising at least one electric motor; at least one gear; at least one first housing part for receiving said at least one electric motor; at least one second housing part for receiving said at least one gear, said electric motor and said gear being connected with one another, and said first housing part and said second housing part being connectable with one another as well; and at least one damping element provided in a connection region between said first housing part and said second housing part.

The hand power tool of the invention includes at least one first housing part for receiving at least one electric motor and at least one second housing part for receiving at least one gear, the electric motor and the gear being connected to one another, and the first housing part and the second housing part are connectable. Advantageously in the hand power tool of the invention, in the connection region between the first housing part and the second housing part, at least one damping element is provided, for vibration damping. The improved vibration properties enhance the user-friendliness of the hand power tool.

By means of the material, shape, thickness, and other parameters, the damping properties of the damping element can be varied. For instance, the damping element may be of an elastic material. As elastic materials, elastomers or foams can for instance be considered.

The damping element may be embodied in one piece, for instance in the form of a ring, with the cross-sectional shape of the ring adapted to the cross-sectional shape of the first and second housing parts in the connection region, so that the damping element produces a damping connection between the two housing parts that extends all the way around. An encompassing damping element can in particular be embodied in profiled form, to increase the vibration absorption. For instance, the damping element may be folded multiple times in the longitudinal direction of the hand power tool, for instance in a rectangular or zigzag shape or in some other shape.

Instead of the one-piece, encompassing damping element, a multi-part damping element may also be provided, so that a plurality of damping elements are distributed over the circumference in the connection region between the first and second housing parts. Here as well, the connection between the two housing parts is made via the damping elements, so that between the two housing parts, no connection comes about except by way of the damping elements.

In a case of a plurality of damping elements distributed over the circumference, the shape of the damping elements can be selected practically arbitrarily and they can be adapted to the damping properties. Moreover, the damping elements distributed over the circumference may be either identical or different, in particular in their shape and their material. The damping elements of elastic material may for instance have the form of bolts.

The damping element may also be a spring element. The spring element may be embodied in the form of a helical spring, spiral spring, leaf spring, cup spring, or some other form of spring. The spring element may be of metal or plastic, for instance. The damping element, in its embodied as a spring element as well, may be adapted in its damping properties by the choice of material, number, location, spring rate, and other parameters. For instance, a plurality of helical springs may be located between the two housing parts and distributed either uniformly or arbitrarily over the circumference of the hand power tool. The helical springs may have identical or different spring rates.

Moreover, the first and second housing parts may also be decoupled from one another or connected to one another in vibration-damped form via a damping element in the form of a damping cushion filled with a fluid, that is, a gas, such as air, or a liquid, such as water, oil, or gel. For instance, an annular damping cushion may be provided, which extends all the way around between the two housing parts. Instead of an encompassing, annular damping cushion, a plurality of individual damping cushions may be distributed over the circumference between the two housing parts.

The damping cushion has a sheath that is impermeable to the fluid, preferably comprising an elastic material. An advantage of a fluid- and in particular gas-filled damping cushion is that with the aid of a comparatively simple construction, the damping cushion can be embodied in such a way that the pressure in the damping cushion is adjustable. For that purpose, the damping cushion may for instance be equipped with a valve, by way of which the pressure in the damping cushion can for instance be adapted to the particular application.

In a further embodiment, the damping element comprises a net, woven fabric, mesh, knitted fabric, or the like, of metal, plastic or natural material, or a combination of these materials.

The damping element may be connected to the first and second housing parts in various ways. The connection may be done by form locking, for instance by means of pegs on the damping element that with the housing parts form an undercut. The connection may also be made by force locking, for instance by means of screws or rivets, or by material locking, such as adhesive bonding or welding. A combination of one or more of these types of connection is also possible. For instance, it can be integrally molded onto the housing parts by injection molding during the molding of the two housing parts. This is done by placing the damping element, such as one or more spring elements, in the void in the injection mold and sheathing the housing parts during the molding in such a way that the damping element is solidly joined to the two housing parts.

A prefabricated damping element comprising an elastic material may also be formed integrally in this way onto the housing parts by injection molding. Alternatively, the damping element comprising a thermoplastic elastomer may be integrally molded directly to the housing parts in a dual-component injection molding process. For attaching the damping element, detent elements may also be provided on one of the housing parts. The connection between the damping element and the first housing part on the one hand and the second housing part on the other can additionally be attained by means of a form lock. To that end, in the connection region, the edges of the two housing parts may be reshaped in such a way that they form a collar, bead, groove, or the like, for instance.

Alternatively, the damping element may be embodied in one piece with one of the two housing parts. For instance, protrusions in the form of spring elements that act as damping elements may be integrally molded onto the first and/or second housing part. These integrally molded spring elements may be of either plastic or metal. For instance, they may be formed integrally in one piece on a first, plastic housing part that receives an electric motor and/or on a second, metal housing part that receives a gear.

The first and second housing parts may be joined by a screw connection, in addition to the damping element. The screw connection is likewise embodied as vibration-damped.

The two housing parts joined together via a damping element may also be overlapping one another in the connection region; the damping element is then located in the overlapping region between the two housing parts.

The hand power tool of the invention includes at least a first housing part for receiving at least one electric motor and at least a second housing part for receiving at least one gear; the electric motor and the gear are connected to one another. In one exemplary embodiment, a drive shaft, drivable by an electric motor, has a driving gear wheel, for instance in the form of a conical pinion with pinion teeth, that is seated on the drive shaft in a manner fixed against relative rotation. A driven gear wheel, for instance in the form of a ring gear with end toothing, that meshes with the driving gear wheel, and a driven shaft driven by the driven gear wheel are also provided. The drive shaft that is drivable by the electric motor protrudes from the first housing part into the second housing part, so that upon a decoupled or vibration-damped connection of the two housing parts with one another, compensation for the relative motion of the two housing parts with respect to one another is necessary. For that purpose, a compensation coupling can for instance be used, of the kind known from the prior art, for instance in the form of a claw coupling, elastomer coupling, or spring joint coupling.

Besides a first and second housing part, further housing parts may be provided. For instance, the handle may form a separate housing part. The housing parts may also be constructed of multiple parts per se, for instance by forming one housing part of two joined-together half shells. The housing parts may be of metal or plastic. For instance, the first housing part for receiving the electric motor may be of plastic, and the second housing part for receiving the gear may be of metal. If further housing parts are provided, for instance for the handle, then these may likewise be of plastic, and the various housing parts of plastic may be of either the same or different plastics.

The hand power tool of the invention may for instance be an electrically drivable right-angle sander, screwdriver, or drill.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a schematic side view of a hand-guided electric right-angle power sander;

FIG. 2 is a detail of the right-angle power sander of FIG. 1, with a damping element in a first embodiment;

FIG. 2a is an enlarged detail of the connection region of the two housing parts of the right-angle power sander of FIG. 2 in cross section;

FIG. 3 is a detail of the right-angle power sander of FIG. 1, with a damping element in a second embodiment;

FIG. 4 is a detail of the right-angle power sander of FIG. 1, with a damping element in a third embodiment;

FIG. 5 is a detail of the right-angle power sander of FIG. 1, with a damping element in a fourth embodiment;

FIG. 5a is an enlarged detail of a further embodiment of a damping element, analogous to FIG. 5;

FIG. 6 is a detail of the right-angle power sander of FIG. 1, with an additional screw connection; and

FIG. 6a is an enlarged view of FIG. 6, with a vibration-decoupled screw connection in a first embodiment.

### DESCRIPTION OF THE PREFERRED EMBODIMENTS

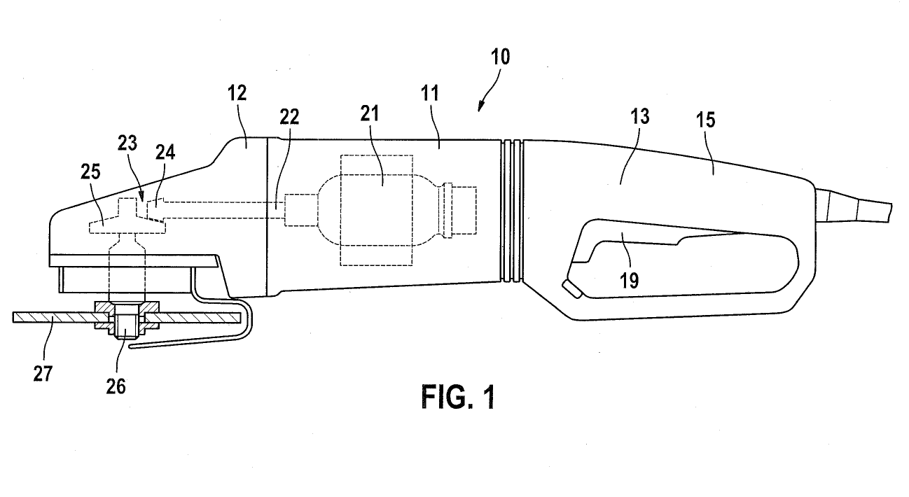

The right-angle power sander 10 shown schematically in FIG. 1 represents one embodiment of the hand power tool of the invention. The right-angle power sander 10 in the embodiment shown includes three housing parts: a first housing part 11 for receiving an electric motor 21, a second housing part 12 for receiving a gear 23 and a third housing part 13, which is embodied as a handle 15. The drive shaft 22 that is drivable by the electric motor 21 is coupled to the driven shaft 26 via the gear 23, which comprises a driving gear wheel 24 and a driven gear wheel 25. A sanding wheel 27 is located on the driven shaft 26 in a manner fixed against relative rotation. The electric motor 21 is switched on and off by the user via an ON/OFF switch 19.

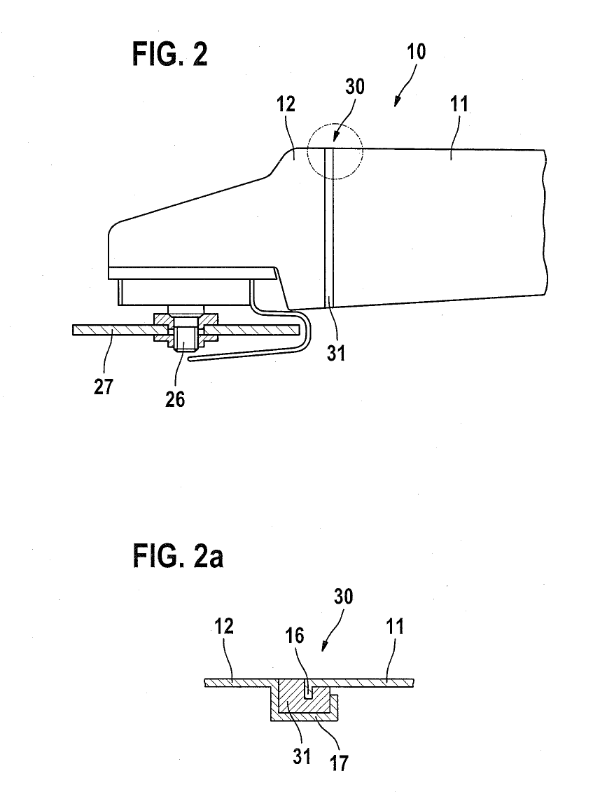

In FIG. 2, a detail of the right-angle power sander 10 of FIG. 1 is shown. In the connection region 30 between the first housing part 11 and the second housing part 12, a damping element 31 is provided according to the invention. By means of the damping element 31, the two housing parts 11, 12 are decoupled from one another and joined to one another in vibration-damping fashion. The embodiment of FIG. 1 involves an essentially annular damping element 31, which extends all the way around, that is, along the circumference of the right-angle power sander 10, between the two housing parts 11, 12.

The damping element 31 is of an elastic material, such as an elastomer, and may be integrally formed onto the housing parts 11, 12, for instance by injection molding. This is shown as an example in an enlarged detail in FIG. 2a. In the connection region 30, the first housing part 11 is provided with a radially inward-oriented collar 16, and the second housing part 12 is provided with a likewise radially inward-oriented groove 17, such that upon integral injection molding of a thermoplastic elastomer, a damping element 31 is embodied between the two housing parts 11, 12 and is joined to the housing parts 11, 12 by form locking.

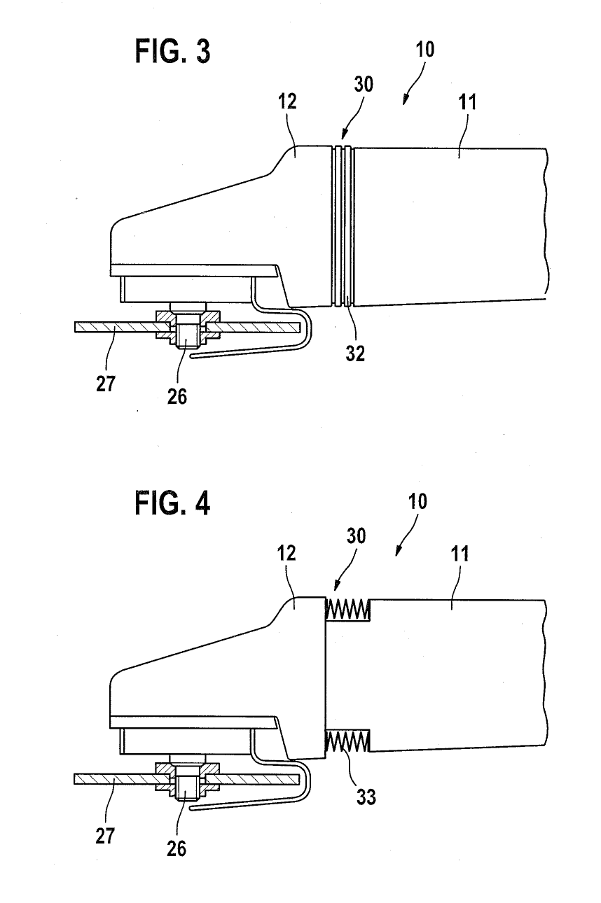

FIG. 3 likewise shows a detail of the right-angle power sander 10 of FIG. 1. In it, a second embodiment of a damping element 32 is shown. Once again, this is an essentially annular damping element 32 of an elastic material, which extends all the way around between the first housing part 11 and the second housing part 12. The vibration absorption is enhanced in the damping element 32 by the provision that the damping element 32 is profiled. The profiled damping element 32 has a folded structure, as a result of which encompassing channels are formed.

In a further embodiment shown in FIG. 4, the damping element is formed by spring elements 33. In the embodiment, four helical springs are provided as spring elements 33, distributed over the circumference between the first housing part 11 and the second housing part 12. Alternatively, still other spring elements 33 may be used, such as leaf springs or cup springs.

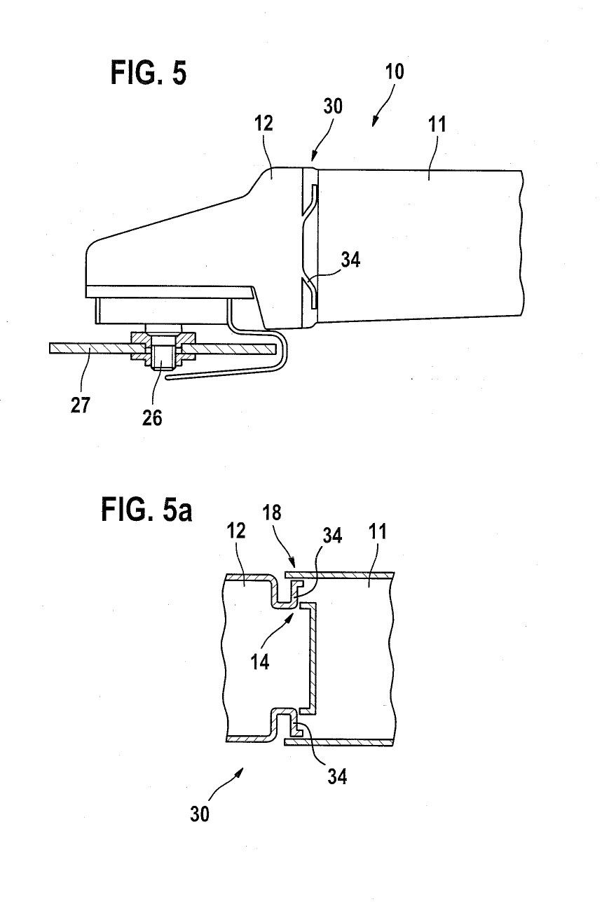

FIG. 5 schematically shows a further embodiment of a damping element, which is embodied as a spring element 34. Unlike the embodiment shown in FIG. 4, however, the spring element 34 is embodied integrally with the second housing part 12. The spring element 34 is formed integrally in tonguelike fashion onto the edge of the second housing part 12 in the connection region 30 and rests on the first housing part 11 in such a way that it enables vibration damping in the longitudinal direction of the right-angle power sander 10. The second housing part 12, which receives the gear 23, is for instance of metal. Accordingly, the spring element 34 shown in FIG. 5 is likewise of metal. Alternatively or in addition, one or more spring elements may be integrally formed in one piece onto the first housing part 11 in a similar way (not shown).

As shown in FIG. 5a, the two housing parts 11, 12 may alternatively be embodied in overlapping fashion in the connection region 30, by providing that the peripheral region 14 of the second housing part 12 is reshaped radially inward in such a way that in the connection region 30, the two housing parts 11, 12 are located parallel to one another. The radially inwardly reshaped peripheral region 14 of the second housing part 12 may be equipped in one piece with spring elements 34 that rest against the inner face of the first housing part 11 in the peripheral region 18 of the first housing part 11.

Analogously, the peripheral region 18 of the first housing part 11, which overlaps the reshaped peripheral region 14 of the second housing part 12, may be provided with radially inward-oriented spring elements, which are formed integrally in one piece onto the housing part 12 and in the reshaped peripheral region 14 rest on the second housing part 12 (not shown). The spring elements 34 may also be embodied in tonguelike fashion, similarly to the embodiment shown in FIG. 5. The spring elements 34 of FIG. 5a allow vibration damping in the radial direction of the right-angle power sander 10.

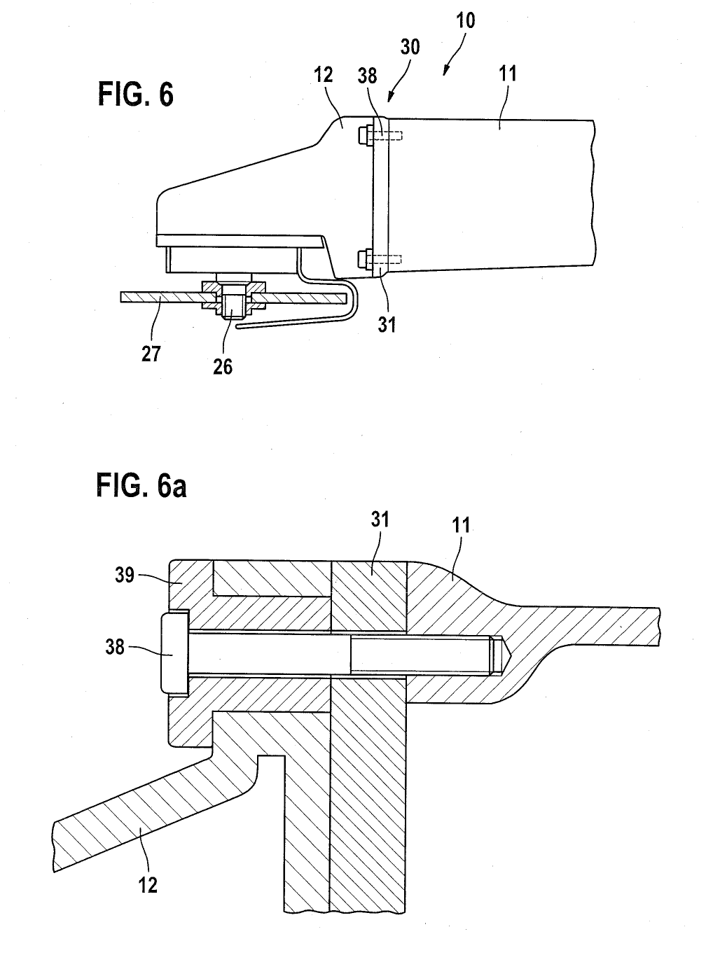

In FIG. 6, shown schematically, the two housing parts 11, 12 are decoupled from one another, for instance by a damping element 31 of an elastic material, and are additionally joined to one another by a vibration-damped screw connection 38. The vibration-decoupled screw connection 38 is shown enlarged in FIG. 6a. In the region of its head, the screw 38 is surrounded by a sleeve 39 of an elastic material. The elastic sleeve 39 may also be embodied in one piece with the damping element 31.

It will be understood that each of the elements described above, or two or more together, may also find a useful application in other types of constructions differing from the type described above.

While the invention has been illustrated and described as embodied in a hand power tool, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A hand power tool, comprising at least one electric motor; at least one gear; at least one first housing part for receiving said at least one electric motor; at least one second housing part for receiving said at least one gear, said electric motor and said gear being connected with one another, and said first housing part and said second housing part being connected with one another as well; and at least one damping element provided in a connection region between said first housing part and said second housing part.

2. A hand power tool as defined in claim 1, wherein said damping element is configured as an element composed of an elastic material.

3. A hand power tool as defined in claim 1, wherein said damping element is configured as an element provided in a profiled form.

4. A hand power tool as defined in claim 1, wherein said damping element is configured as an element composed of multiple parts.

5. A hand power tool as defined in claim 1, wherein said damping element is configured as a spring element.

6. A hand power tool as defined in claim 5, wherein said spring element is formed as a one-piece element with at least one of said first and second housing parts.

7. A hand power tool as defined in claim 1; and further comprising a screw connection provided between said first housing part and said second housing part and configured in a vibration-damped form.
